(19) United States
(12) Patent Application Publication
(10) Pub. No.: US 2026/0108810 A1
(43) Pub. Date: Apr. 23, 2026

(54) INFORMATION INTERACTION METHOD AND APPARATUS, AND ELECTRONIC DEVICE AND STORAGE MEDIUM

(71) Applicant: NETEASE (HANGZHOU) NETWORK CO., LTD., Hangzhou, Zhejiang (CN)

(72) Inventor: Xiaoxue HAN, Hangzhou, Zhejiang (CN)

(73) Assignee: NETEASE (HANGZHOU) NETWORK CO., LTD., Hangzhou, Zhejiang (CN)

(21) Appl. No.: 18/998,140

(22) PCT Filed: Mar. 17, 2023
(86) PCT No.: PCT/CN2023/082269

§ 371 Date: Jan. 5, 2026

(30) Foreign Application Priority Data
Aug. 2, 2022 (CN) 202210922200.7

(51) Int. Cl. A63F 13/533; A63F 13/2145

(52) U.S. Cl. CPC A63F 13/533; A63F 13/2145

(57) ABSTRACT

Provided in the present disclosure are an information interaction method and apparatus, and an electronic device and a storage medium. The method comprises: in response to any avatar of a team, to which a first avatar belongs, completing an unlocking task, displaying, in an icon display area, an unlocked icon corresponding to the unlocking task; in response to a first trigger operation for a first target task icon among icons of unlocked tasks, determining a first target task; determining a first target sub-task according to the positional relationship between the current location of the first avatar and a task location of each sub-task of the first target task, and displaying the first target sub-task and a first indication sign, which guides the first avatar to head for the task location; and displaying, in an information bar, notification information of the first avatar executing the first target task.

### CROSS REFERENCE TO RELATED APPLICATIONS

The present disclosure is a U.S. National Stage of International Application No. PCT/CN2023/082269, filed on Mar. 17, 2023, which claims priority to the Chinese patent application with application number 202210922200.7 and titled “Information Interaction Method and Apparatus, Electronic Device, Storage Medium” filed on Aug. 2, 2022. The entire contents of both applications are fully incorporated herein by reference.

### TECHNICAL FIELD

The present disclosure relates to the technical field of computer, and in particular, to an information interaction method and apparatus, an electronic device, and a storage medium.

### BACKGROUND

With the development of Internet technology, people's entertainment activities have become increasingly diverse; in particular, video games are becoming more and more popular. In multi-player cooperative games, effective and good communication between teammates can not only make the cooperation between teammates more tacit, but also improve the winning rate of the game and improve the player's gaming experience.

In the related art, there are mainly two ways of communication between teammates. One is voice communication realized by the user turning on the microphone; the other is text communication realized by the user inputting text on the virtual keyboard or physical keyboard to display the text in the information bar. Communication through voice has space limitations; and communication through typing is obviously inefficient and may affect current game operations.

It should be noted that the information disclosed in the above background section is only used to enhance understanding of the background of the present disclosure, and therefore may include information that does not constitute prior art known to those of ordinary skill in the art.

### SUMMARY

In an information interaction method, a first virtual object in a game is controlled through a first terminal, the first terminal provides a first user interface, the first user interface includes an icon display area, and the icon display area is used to display a current game stage, and a team-related task icon, the method includes:
in response to any virtual object of a team to which the first virtual object belongs completing an unlocking task, displaying an unlocked task icon corresponding to the unlocking task in the icon display area;
in response to a first trigger operation for a first target task icon in the unlocked task icon, determining that the first virtual object executes a first target task corresponding to the first target task icon;
according to a positional relationship between a current position of the first virtual object and a task location of each subtask of the first target task, determining a first target subtask executed by the first virtual object, and displaying the first target subtask and a first indication mark on the first user interface, where the first indication mark is used to guide the first virtual object to go to a task location corresponding to the first target subtask; and
displaying notification information that the first virtual object executes the first target task in an information bar of the first user interface, where the information bar is used to display chat information between virtual objects of the team to which the first virtual object belongs.

In an information interaction apparatus, a first virtual object in a game is controlled through a first terminal, the first terminal provides a first user interface, the first user interface includes an icon display area, and the icon display area is used to display a current game stage, and a team-related task icon, the apparatus including:
an icon unlocking module, configured to, in response to any virtual object of a team to which the first virtual object belongs completing an unlocking task, display an unlocked task icon corresponding to the unlocking task in the icon display area;
a first determination module, configured to, in response to a first trigger operation for a first target task icon in the unlocked task icon, determine that the first virtual object executes a first target task corresponding to the first target task icon;
a second determination module, configured to, according to a positional relationship between a current position of the first virtual object and a task location of each subtask of the first target task, determine a first target subtask executed by the first virtual object, and display the first target subtask and a first indication mark on the first user interface, where the first indication mark is used to guide the first virtual object to go to a task location corresponding to the first target subtask; and
a message display module, configured to display notification information that the first virtual object executes the first target task in an information bar of the first user interface, where the information bar is used to display chat information between virtual objects of the team to which the first virtual object belongs.

An electronic device includes a processor, a memory, and a computer program stored on the memory and capable of running on the processor, and when the computer program is performed by the processor, the steps of the information interaction method as described above are implemented.

A computer-readable storage medium stores a computer program on the computer-readable storage medium, and when the computer program is performed by a processor, the steps of the information interaction method as described above are implemented.

### BRIEF DESCRIPTION OF THE DRAWINGS

In order to explain the technical solutions of the present disclosure more clearly, the drawings needed to be used in the description of the present disclosure will be briefly introduced below. Obviously, the drawings in the following description are only some embodiments of the present disclosure, and the person skilled in the art can also obtain other drawings based on these drawings without exerting creative labor.

FIG. 1 is a schematic diagram of an implementation environment of an embodiment of the present disclosure;

FIG. 2 is a step flowchart of an information interaction method according to an embodiment of the present disclosure;

FIG. 3 is a schematic diagram of an interface of an information interaction method according to an embodiment of the present disclosure;

FIG. 4 is a schematic diagram of an interface when displaying notification information in an information interaction method according to an embodiment of the present disclosure;

FIG. 5 is a schematic diagram of a task icon of an information interaction method according to an embodiment of the present disclosure;

FIG. 6 is a schematic diagram of an interface when displaying a virtual object identification in an information interaction method according to an embodiment of the present disclosure;

FIG. 7 is a schematic diagram of an interface when displaying first interaction information in an information interaction method according to an embodiment of the present disclosure;

FIG. 8 is a schematic diagram of an interface when canceling the target virtual object identification in an information interaction method according to an embodiment of the present disclosure;

FIG. 9 is a schematic diagram of an interface when canceling the display of a virtual object identification in an information interaction method according to an embodiment of the present disclosure;

FIG. 10 is a schematic diagram of an interface when receiving second interaction information in an information interaction method according to an embodiment of the present disclosure;

FIG. 11 is a schematic diagram of an interface when accepting second interaction information in an information interaction method according to an embodiment of the present disclosure. intention;

FIG. 12 is a structural block diagram of an information interaction apparatus according to an embodiment of the present disclosure.

### DETAILED DESCRIPTION

In order to make the above objects, features and advantages of the present disclosure more obvious and understandable, the present disclosure will be described in further detail below in conjunction with the accompanying drawings and specific implementations. Obviously, the described embodiments are some, but not all, of the embodiments of the present disclosure. Based on the embodiments in the present disclosure, all other embodiments obtained by those of ordinary skill in the art without making creative efforts fall within the scope of protection of the present disclosure.

First, the terms involved in the embodiments of the present disclosure are introduced.

Virtual environment: it is a virtual environment displayed (or provided) when the application is running on the terminal. The virtual environment may be a simulation environment of the real world, a semi-simulation and semi-fictional environment, or a purely fictional environment. The virtual environment may be any one of a two-dimensional virtual environment, a 2.5-dimensional virtual environment, and a three-dimensional virtual environment, which is not limited by the present disclosure. Optionally, the virtual environment includes a plurality of virtual areas associated with tasks. For each virtual area, only after the associated task has unlocked, the virtual object can go to this virtual area to execute the related task.

Virtual environment screen: a virtual camera is generally set up in a game scene, and the content of the game scene captured by the virtual camera is the virtual environment screen presented by the user interface. Optionally, the virtual environment screen may be a screen generated when the virtual environment is observed from a perspective corresponding to the main control virtual object. The perspective corresponding to the main control virtual object may be any one of the first-person perspective, downward and upward 45° perspectives, the third-person perspective, and the over-the-shoulder perspective of the main control virtual object.

Virtual object: it refers to a movable object in the virtual environment. The movable object may be a virtual character, a virtual animal, an animation character, a virtual apparatus, etc., such as: a character, an animal, and an airplane displayed in the three-dimensional virtual environment. In multi-player cooperative games, effective and good communication between teammates can not only make the cooperation between teammates more tacit, but also improve the winning rate of the game and improve the player's gaming experience.

In the related art, there are two main ways of communication between teammates. One is through the user turning on the microphone for voice communication; the other is through the user inputting text on the virtual keyboard or physical keyboard to display the text in the information bar for communication.

Currently, many games are mobile phone games (referred to as mobile games). When users use the mobile phones to run games, they may be in places that are not suitable for talking. There are also situations where some users are unwilling to start voice conversations with strangers. Therefore, there are space restrictions in the way of voice communication, and it may also cause network lags.

For mobile phones, touch screen typing on the game interface not only affects typing efficiency, but also interrupts the current game operation.

In view of this, the embodiments of the present disclosure provide an information interaction system that can not only quickly send interaction information without space restrictions, but also send interaction information in a targeted manner, thereby improving communication efficiency and reducing communication costs.

Referring to FIG. 1, FIG. 1 shows a schematic diagram of an implementation environment provided by an embodiment of the present disclosure. The implementation environment may include: a first terminal 110, a server 120 and a second terminal 130.

The first terminal 110 runs an application that supports a virtual environment, and the application may be a multi-player online battle program. When the first terminal runs the application, the user interface of the application is displayed on the screen of the first terminal 110. The application may be any one of a multi-player online tactical competitive game, a multi-player online role-playing game, a battle royale shooting game, a simulation strategy game, etc. In this embodiment, the application is a multi-player online role-playing game as an example. The first terminal 110 is a terminal used by the first user 111. The first user 111 uses the first terminal 110 to control the first virtual object located in the virtual environment to perform activities. The first virtual object may be called a main control virtual object of the first user 111.

The second terminal 130 runs an application that supports a virtual environment, and the application may be a multi-player online battle program. When the second terminal 130 runs the application, the user interface of the application is displayed on the screen of the second terminal 130. The application may be any one of a multi-player online tactical competitive game, a multi-player online role-playing game, a battle royale shooting game, a simulation strategy game, etc. In this embodiment, the application is a multi-player online role-playing game as an example. The second terminal 130 is a terminal used by the second user 131. The second user 131 uses the second terminal 130 to control the second virtual object located in the virtual environment to perform activities. The second virtual object may be called the main control virtual object of the second user 131.

Optionally, the first virtual object and the second virtual object are in the same virtual world.

Optionally, the virtual world may be a virtual world of an instance scene. The instance scene is composed of a set of independent map scenes. The user can control the corresponding virtual object to play the game here, for example, control the virtual object to kill the monster in the instance scene to obtain game resources such as virtual equipment or gold coins dropped by the monster. The first virtual object and the second virtual object may belong to the same team, the same camp, the same organization, have a friend relationship, or have temporary communication permissions.

Optionally, the applications running on the first terminal 110 and the second terminal 130 are the same, or the applications running on the two terminals are the same type of applications on different operating system platforms (such as Android or IOS). The first terminal 110 may generally refer to one of a plurality of terminals, and the second terminal 130 may generally refer to another of the plurality of terminals. This embodiment only takes the first terminal 110 and the second terminal 130 as an example. The device types of the first terminal 110 and the second terminal 130 are the same or different, and the device types include at least one of a game console, a smartphone, a tablet computer, an e-book reader, a laptop computer, a desktop computer, and the like. The following embodiments take the device as a smartphone as an example.

Only two terminals are shown in FIG. 1, but there are a plurality of other terminals that can access the server 120 in different embodiments. Optionally, there are one or more terminals corresponding to the developer. The terminal is installed with a development and editing platform for the application that supports the virtual environment. The developer can edit and update the application on the terminal, and transmit the updated application installation package to the server 120 through a wired or wireless network. The first terminal 110 and the second terminal 130 can download the application installation package from the server 120 to update the application.

The first terminal 110, the second terminal 130 and other terminals are connected to the server 120 through a wireless network or a wired network.

The server 120 includes at least one of a server, a server cluster composed of a plurality of servers, a cloud computing platform, and a virtualization center. The server 120 is used to provide background services for the application supporting the virtual environment. Optionally, the server 120 undertakes the main calculation work and the terminal undertakes the secondary calculation work; or the server 120 undertakes the secondary calculation work and the terminal undertakes the main calculation work; or the server 120 and the terminal perform collaborative computing by using a distributed computing architecture.

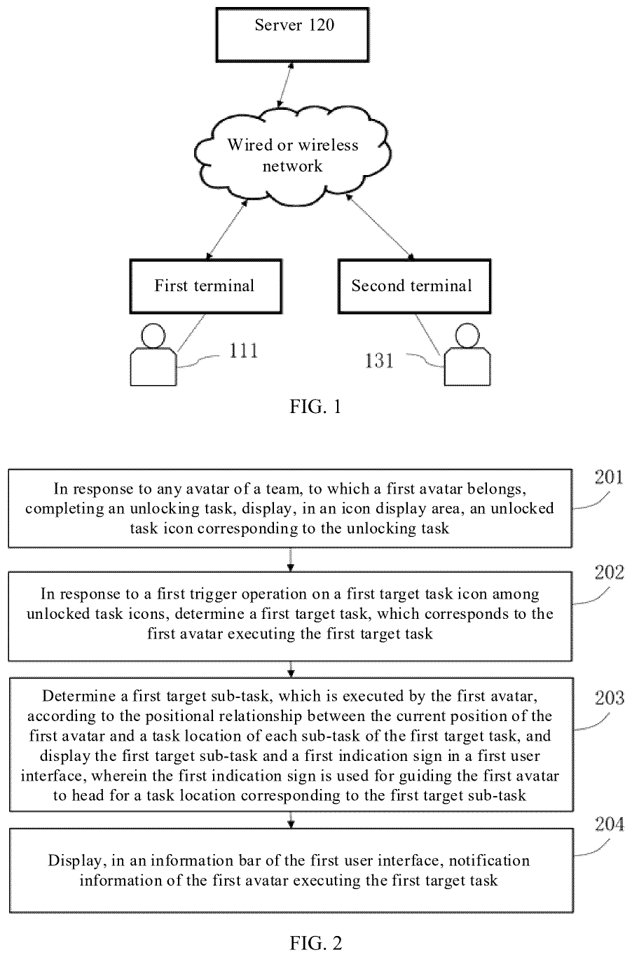

Referring to FIG. 2, a flowchart of steps of an information interaction method provided by an embodiment of the present disclosure is shown. The embodiment of the present disclosure can be applied to a scenario where a plurality of users enter a game instance to play the game, the first terminal controls a first virtual object in the game, and a second virtual object controlled by the second terminal is also included in the same game. It can be understood that the user can control the first virtual object through interaction with the first terminal, and can control the second virtual object through interaction with the second terminal. The first terminal provides a first user interface. The first user interface includes an icon display area and an information bar. The icon display area is used to display task icon(s) related to the current game stage and the team. The information bar is used to display chat information between the first virtual object and the first virtual object, i.e., the information bar is used to display the chat information between the virtual objects of the team to which the first virtual object belongs. That is, the information displayed in the information bar of the first user interface can be displayed synchronously to the second user interface of the second terminal. In the embodiment of the present disclosure, the method may include the following steps.

In step 201, in response to any virtual object of the team to which the first virtual object belongs completing an unlocking task, an unlocked task icon corresponding to the unlocking task is displayed in the icon display area.

In step 202, in response to a first trigger operation on a first target task icon in the unlocked task icon(s), it is determined that the first virtual object executes a first target task corresponding to the first target task icon.

In step 203, according to a positional relationship between a current position of the first virtual object and a task location of each subtask of the first target task, a first target subtask executed by the first virtual object is determined, and the first target subtask and a first indication mark are displayed on the first user interface, where the first indication mark is used to guide the first virtual object to go to a task location corresponding to the first target subtask.

In step 204, notification information that the first virtual object executes the first target task is displayed in the information bar of the first user interface.

In the embodiments of the present disclosure, in response to any virtual object of the team to which the first virtual object belongs completes the unlocking task, the unlocked icon corresponding to the unlocking task is displayed in the icon display area; in response to the first trigger operation for the first target task icon in the unlocked task icon(s), it is determined that the first virtual object executes the first target task corresponding to the first target task icon; according to the positional relationship between the current position of the first virtual object and the task location of each subtask of the first target task, the first target subtask executed by the first virtual object is determined, and the first target subtask and the first indication mark are displayed on the first user interface, where the first indication mark is used to guide the first virtual object to go to the task location corresponding to the first target subtask; notification information that the first virtual object executes the first target task is displayed in the information bar of the first user interface, where the information bar is used to display chat information between virtual objects of the team to which the first virtual object belongs. In this way, not only the task that the user wants to execute can be prompted, but also information can be shared, the task currently executed can be synchronized with teammates in a targeted manner, and the communication efficiency with teammates can be improved.

The information interaction method in this exemplary embodiment will be further described below.

The user can log in to his/her game account through the terminal, and control the virtual object corresponding to the account through the terminal that logs in to his/her game account. The first terminal may refer to a terminal corresponding to any virtual object among a plurality of virtual objects participating in the same game. In order to facilitate understanding of the information interaction method provided by the embodiments of the present disclosure, the information interaction method provided by this embodiment is exemplified below from the perspective of the first terminal, while the second terminal generally refers to other terminal(s) in the same game except the first terminal.

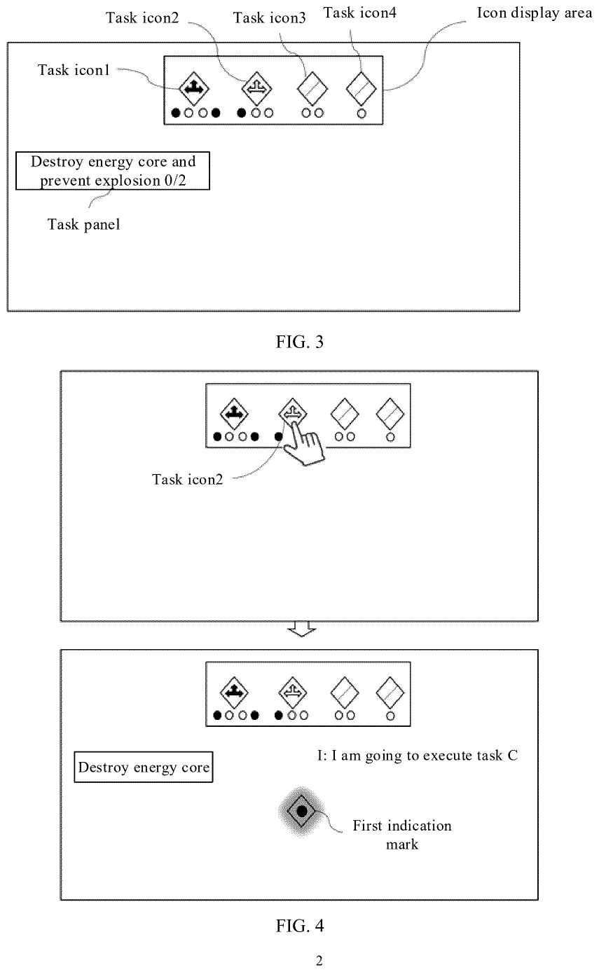

The first terminal provides a first user interface for interacting with the user through the first user interface. The first user interface may include a variety of interfaces. For example, it may be rendered and displayed on the display screen of the first terminal, or provided to the user through holographic projection. For example, the first terminal may include a touch display screen and a processor. The processor is used to run a game application to generate the first user interface and control the first user interface to be displayed on the touch display screen. The first user interface includes the virtual environment screen, the icon display area and the information bar. The icon display area is used to display task icon(s) related to the team. For example, the icon display area may display all task icon(s) to be completed by the team in the current game stage; the icon display area as shown in FIG. 3 displays task icon 1, task icon 2, task icon 3 and task icon 4, to indicate that in the current game stage, the team to which the first virtual object belongs needs to complete 4 tasks before entering the next game stage. Optionally, the icon display area may also display unlocked task icon(s) completed by the team in the current game stage, or unlocked and uncompleted task icon(s), etc.

In step 201, in response to any virtual object of the team to which the first virtual object belongs completing an unlocking task, an unlocked task icon corresponding to the unlocking task is displayed in the icon display area.

The task icons in the embodiments of the present disclosure are related to the team, and there are at least some tasks in the current game stage that require completing the unlocking task before they can be unlocked. The unlocking task may include killing the corresponding monster, the total value of the team's virtual assets reaching the specified number of assets. etc., that is, the game behavior of any virtual object in the team can be related to the tasks of the team, including unlocking the task corresponding to the task icon, completing the task corresponding to the task icon, etc., and the virtual object can only execute the unlocked task.

In some optional embodiments of the present disclosure, unlock information of the corresponding task may be displayed in the task icon displayed in the icon display area. The unlock information includes unlocked and not unlocked. When the unlock information of the task is unlocked, the corresponding task icon is displayed normally in the icon display area. Task icon 1 and task icon 2 in FIG. 3 are both task icons corresponding to the unlocked tasks. When the unlock information of the task is not unlocked, the corresponding task icon is grayed out in the icon display area. As shown in FIG. 3, task icon 3 and task icon 4 are both task icons corresponding to the unlocked tasks. Optionally, only the unlocked task icon(s) may be displayed in the icon display area, and the not unlocked task icon(s) may not be displayed.

When any virtual object (including the first virtual object and the second virtual object) in the team to which the first virtual object belongs completes the unlocking task, the unlock information of the task icon corresponding to the unlocking task may be updated to unlocked. Optionally, when only the unlocked task icon(s) is displayed in the image display area, the task icon(s) corresponding to the unlocked task(s) may also be added to the image display area.

In step 202, in response to a first trigger operation on a first target task icon in an unlocked task icon(s), it is determined that the first virtual object executes a first target task corresponding to the first target task icon.

Different task icons correspond to different tasks. During the game, the user generally needs to adjust the task(s) executed according to the actual game conditions. In multi-player games, members of the same team can improve the overall combat effectiveness of the team by reasonably allocating the tasks they execute. In this embodiment, the first target task corresponding to the first target task icon is different from the task currently executed by the first virtual object. Optionally, the first target task corresponding to the first target task icon is an uncompleted task, that is, the first target task icon is a task icon of an unlocked and uncompleted task. The first trigger operation may be a long press operation, a click operation, a sliding operation whose sliding trajectory conforms to a first preset trajectory, etc., acting on an area where the first target task icon is located.

When the user wants to control the first virtual object to execute the first target task, the first trigger operation for the first target task can be performed; for the information interaction system, when the first trigger operation for the first target task icon is detected, it can be determined that the first virtual object will execute the first target task.

In step 203, according to a positional relationship between a current position of the first virtual object and a task location of each subtask of the first target task, a first target subtask executed by the first virtual object is determined, and the first target subtask and a first indication mark are displayed on the first user interface, where the first indication mark is used to guide the first virtual object to go to a task location corresponding to the first target subtask.

In this embodiment, the task corresponding to each task icon may include at least one subtask. When the first target task includes a plurality of subtasks, the first target subtask executed by the first virtual object may be further determined according to the positional relationship between the current position of the first virtual object and the task location of each subtask of the first target task. For example, the current position of the first virtual object refers to the position of the first virtual object in the game virtual environment, and the first target subtask executed by the first virtual object can be determined by calculating a distance or a path length between the current position of the first virtual object and the task location of each subtask of the first target task. For example, the subtask corresponding to the task location with the shortest distance or the shortest path from the current position of the first virtual object may be determined as the first target subtask.

Since the first target task belongs to the tasks of the team, each subtask of the first target task can also be executed and completed by the second virtual object. The above process of determining the first target subtask executed by the first virtual object according to the positional relationship between the current position of the first virtual object and the task location of each subtask of the first target task may also include: determining the first target subtask executed by the first virtual object according to the positional relationship between the current position of the first virtual object and the task location of each subtask in the uncompleted state of the first target task.

Optionally, each subtask of the first target task may also have a sequence. In this case, the subtask in the first target task that is executed first and is in an uncompleted state may be determined as the first target subtask executed by the first virtual object.

In order to facilitate the user to understand the specific content of the task currently to be executed, the first target subtask may be displayed in the first user interface. For example, as shown in FIG. 3, the first user interface may include a task panel used to display the task currently executed by the first virtual object. Optionally, the progress information of the first target subtask can also be displayed in the first user interface so that the user can learn the task completion status. For example, the progress information of the currently executed task is displayed in the task panel. In FIG. 3, the task panel displays “Destroy energy core and prevent explosion 0/2”, indicating that the task currently executed by the first virtual object is to destroy the energy core and prevent the explosion, and the corresponding progress information is 0/2, where 2 means that there are two energy cores that need to be destroyed, and 0 means that the number of energy cores that have been destroyed currently is 0.

Different tasks correspond to different virtual areas in the virtual environment. In order to facilitate the user to control the first virtual object to go to the task location of the first target subtask, a first indication mark may be displayed in the first user interface. The first indication mark is used to guide the first virtual object to go to the task location corresponding to the first target subtask. For example, the specific display position of the first indication mark in the first user interface may be determined according to the orientation relationship between the current position of the first virtual object and the task location of the first target subtask to guide the user to control the first virtual object to go towards the first indication mark, to reach the task location corresponding to the first target subtask. Optionally, the first indication mark can also be added with special effects such as flashing to serve as a conspicuous reminder. The flashing special effect can last for a specified duration, such as 5 seconds.

In step 204, notification information that the first virtual object executes the first target task is displayed in the information bar of the first user interface.

When it is determined that the first virtual object executes the first target task, notification information may also be displayed in the information bar to share with the second terminal user the information that the first virtual object is going to execute the first target task.

As shown in FIG. 4, the first target task is task C corresponding to task icon 2. When the first trigger operation for task icon 2 is detected, it is determined that the first virtual object executes task C. Task C may include two subtasks of taking the rocket launcher and destroying the energy core. According to the distances between the current position of the first virtual object and the task location of taking the rocket launcher and the task location of destroying the energy core, the subtask corresponding to the task location that has a smaller distance from the current position of the first virtual object is determined as the first target subtask of the first virtual object. In FIG. 4, the first target subtask is to destroy the energy core. Therefore, the task information of destroying the energy core is displayed in the task panel, and the first indication mark for guiding the first virtual object to go to the task location of destroying the energy core is displayed in the first user interface, and notification information is displayed in the information bar. The content of the notification information may be “I: I am going to execute task C”, where task C is the first target task. “I” may also be represented by the identification of the first virtual object. The identification of the first virtual object may be the name, account number of the first virtual object, number of the first virtual object in the team, etc. In the second user interface of the second terminal, the corresponding display content is “First virtual object identification: I am going to execute task C”.

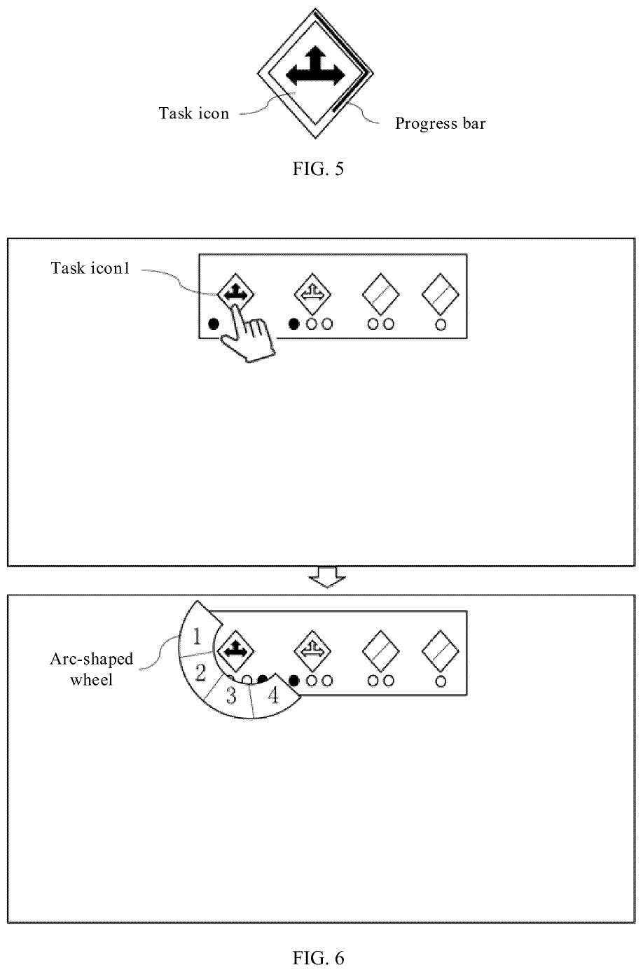

Furthermore, in order to facilitate the user to know the completion status of each task, in some optional embodiments of the present disclosure, the corresponding task completion progress information may also be displayed in the task icon. As shown in FIG. 5, the task completion progress information may be displayed through a progress bar surrounding the task icon. The task completion progress information may also be displayed through a score, a percentage, or a linear progress bar, which is not limited by the present disclosure.

In order to facilitate the user to obtain the personnel allocation of each task, in some optional embodiments of the present disclosure, the number of virtual objects currently executing the corresponding task may also be displayed in the task icon. The number of virtual objects is the sum of the first virtual object and the second virtual object currently executing the corresponding task. For example, as shown in FIG. 3, the number of black dots below the task icon is the number of virtual objects currently executing the corresponding task. The number of virtual objects may also be displayed at the corresponding position of the task icon. Preferably, the virtual object identifications of the virtual objects currently executing the corresponding task may also be displayed at the corresponding position of the task icon to facilitate the user to know the number of virtual objects currently executing the corresponding task and the specific virtual objects.

Optionally, in some embodiments, the number of the virtual objects that execute the same task needs to be controlled within the maximum number of virtual objects of the corresponding task. Therefore, in some embodiments, the maximum number of virtual objects that are allowed to execute the corresponding task simultaneously can also be displayed in the task icon. For example, as shown in FIG. 3, the number of dots (including black dots and white dots) below the task icon is the maximum number of virtual objects that are allowed to execute the corresponding task simultaneously. The figure of the maximum number of virtual objects can also be displayed at the corresponding position of the task icon. Optionally, the maximum number of virtual objects and the number of virtual objects currently executing the corresponding task can be displayed at the corresponding position of the task icon. For example, as shown in FIG. 3, the total number of black dots and white dots below the task icon represents the maximum number of virtual objects that are allowed to execute the corresponding task at the same time, and the number of black dots represents the number of virtual objects currently executing the corresponding task. Preferably, the black dot can also be represented by the virtual object identification of the virtual object currently executing the corresponding task.

Further, in an optional embodiment of the present disclosure, the above information interaction method may further include:
in response to task completion progress information of the task icon(s) in the current game stage being completed, the first virtual object is controlled to enter the next game stage, and the task icon(s) displayed in the icon display area is updated.

When all tasks in the current game stage are completed, the first virtual object can be controlled to enter the next game stage. After entering the next game stage, the team-related task icon(s) corresponding to the next game stage can be obtained, and based on the obtained task icon(s), the task icon(s) displayed in the icon display area is updated.

Optionally, the next game stage can be determined by the user. In the next game stage, the first virtual object can regroup; the next game stage can also be automatically determined by the system. In the next game stage, the current team can be retained.

Further, in an optional embodiment of the present disclosure, the above information interaction method may further include:
in response to a second trigger operation for a second target task icon in the unlocked task icon(s), displaying a virtual object identification of the second virtual object;
in response to a third trigger operation for a target virtual object identification in the virtual object identification(s), displaying first interaction information in the information bar, where the first interaction information is used to indicate the second target virtual object corresponding to the target virtual object identification to execute the second target task corresponding to the second target task icon;
sending the first interaction information to the target second terminal corresponding to the target second virtual object in the second terminal, so that a first pop-up window is simultaneously displayed in the target second user interface of the target second terminal; where the first pop-up window is used to receive a response operation of whether to accept the first interaction information.

In this embodiment, the user who controls the first virtual object can not only control the specific tasks executed by the first virtual object, but can also provide suggestions for executing tasks for the second virtual object.

When the user wants to provide one or more second virtual objects with suggestions for executing the first target task, the first user interface may display the virtual object identification of the second virtual object through a second trigger operation. The second trigger operation may be a long press operation, a click operation, a sliding operation whose sliding trajectory conforms to a second preset trajectory, etc., acting on the area where the second target task icon is located. It should be noted that the second trigger operation is different from the first trigger operation. For example, the first trigger operation may be a double-click operation, and the second trigger operation may be a long-press operation.

As shown in FIG. 4, task icon 1 is the second target task icon, and the second trigger operation acts on the area where the second target task icon is located. Taking the second trigger operation as a long press operation as an example, when the first terminal detects a long press operation acting on the area where the second target task icon is located with the touch duration reaching the long press operation duration requirement, the virtual object identification of the second virtual object is displayed in the first user interface. 1, 2, 3, and 4 in the arc-shaped wheel in FIG. 6 are used to represent different virtual object identifications respectively. It can be understood that the virtual object identification may be one of or a combination of the virtual object's number, name, avatar, or account number, etc., to represent a unique virtual object.

Exemplarily, the above-mentioned display of the virtual object identification of the second virtual object in response to the second trigger operation for the second target task icon in the unlocked task icon(s) may include:
in response to the second trigger operation acting on the second target task icon, generating a cluster layer, and displaying the cluster layer on the first user interface;
displaying the virtual object identification(s) of at least part of the second virtual objects in the cluster layer.

When the second trigger operation for the second target task icon is detected, the first terminal may generate a cluster layer, display the cluster layer in the first user interface, and display the virtual object identification(s) of part or all of the second virtual objects in the cluster layer.

Preferably, as shown in FIG. 6, the cluster layer is in the shape of an arc-shaped wheel. The above display of the cluster layer on the first user interface may include:
displaying the arc-shaped wheel around the second target task icon in the first user interface.

In this embodiment, the cluster layer may be displayed in the shape of an arc-shaped wheel. Optionally, the center of the arc-shaped wheel coincides with the center point of the second target task icon. The virtual object identifications are displayed in the arc-shaped wheel around the second target task icon. When the second trigger operation is a long press or click operation, the target virtual object identification can be selected by moving a relatively short distance. Therefore, it is convenient for the user to operate. At the same time, compared with other shapes, the arc-shaped wheel can display relatively more virtual object identifications around the second task icon, and is more beautiful.

In an example, the icon display area can display all task icons. At this time, the user can directly determine the second target task icon from the unlocked task icons displayed in the icon display area, and perform the second trigger operation acting on the second target task icon, to cause the first user interface to display the virtual object identification of the second virtual object.

In another example, the icon display area displays some task icons. When the second target task icon is not displayed in the icon display area, by the first sliding operation acting on the icon display area, the user can control the task icons displayed in the icon display area to slide in the sliding direction corresponding to the first sliding operation, to update the task icons displayed in the display area task icon until the second target task icon is displayed in the icon display area. Alternatively, the user can expand the icon display area through a click operation acting on the first expanded display control in the icon display area, so that all task icons are displayed in the icon display area. Then, a second trigger operation acting on the area where the second target task icon is located is performed, so that the first user interface displays the virtual object identification of the second virtual object.

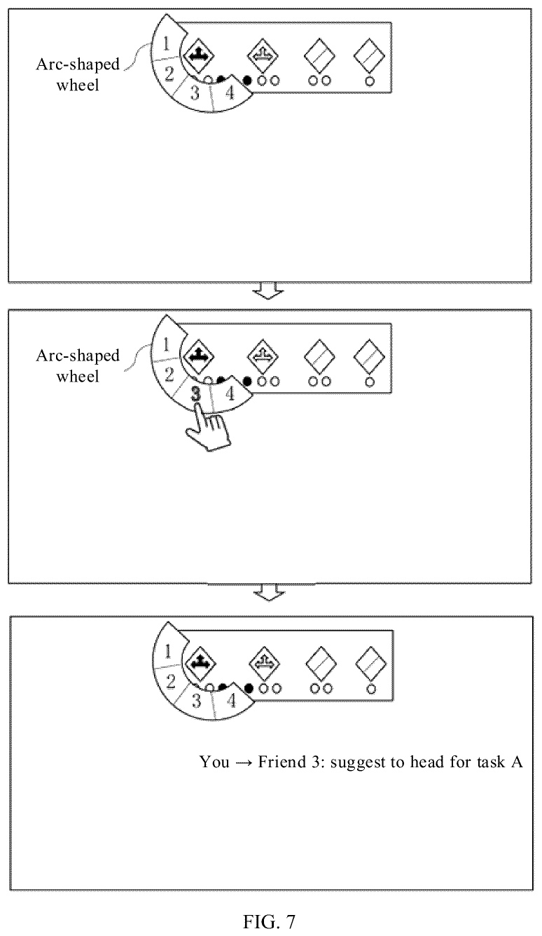

After the user determines the target second virtual object that is suggested to execute the second target task, the target virtual object identification of the target second virtual object can be determined from the virtual object identification, and the third trigger operation is performed to display the first interaction information for indicating the target second virtual object to execute the second target task in the information bar. The third trigger operation may be a long press operation, a click operation, a sliding operation whose sliding trajectory conforms to the third preset trajectory, etc., acting on the area where the target second virtual object is located. As shown in FIG. 7, the virtual object identification 3 in the arc-shaped wheel is the target virtual object identification. Taking the third trigger operation as a click operation as an example, when the click operation acting on the area where the virtual object identification 3 is located is detected by the first terminal, the first interaction information is displayed in the information bar of the first user interface. The content of the first interaction information in FIG. 7 is: “You→Friend 3: suggest to head for task A.” “Friend 3” in the first interaction information in FIG. 7 may be the game name of the target second virtual object, and “You” is used to represent the first virtual object. It should be noted that in the second user interface of the second terminal, “You” may be represented by the game name of the first virtual object. In the first user interface, “You” can also be represented by the game name of the first virtual object. “Friend 3” can also be represented by “You” in the target second user interface of the target second terminal.

Exemplarily, the above-mentioned display of the first interaction information in the information bar in response to the third trigger operation for the target virtual object identification in the virtual object identification(s) may include:
in response to a touch operation acting on the area where any virtual object identification is located, adding a visual identification to the virtual object identification in the area where the touch point is located, and determining the virtual object identification with the added visual identification as the target virtual object identification;
in response to the touch operation disappearing, displaying first interaction information in the information bar.

When the operating medium (such as finger, stylus, etc.) comes into contact with the touch display screen of the first terminal, and the contact point is in the area where any virtual object identification is located, it is determined that the touch operation acting on the area where any virtual object identification is located is detected. The contact point is the touch point, a visual identification is added to the virtual object identification in the area where the touch point is located, and the visual identification may be to change the background color of the virtual object identification, or highlight the virtual object identification, etc. At the same time, the virtual object identification of the area where the touch point is located is determined as the target virtual object identification, that is, the virtual object identification with added visual identification is determined as the target virtual object identification. As shown in FIG. 7, the target virtual object identification is virtual object identification 3. When the operating medium leaves the touch display screen, it is determined that the touch operation disappears, and at this time, the first interaction information is displayed in the information bar. At this time, the virtual wheel can continue to be displayed, so that when the user needs to send suggestions to a plurality of second virtual objects to suggest to go to execute the first target task, the user does not need to repeatedly perform the same second trigger operation. In some embodiments, the virtual wheel can also be hidden while the touch operation disappears.

Optionally, after the above-mentioned determination of the virtual object identification of the area where the touch point is located as the target virtual object identification, the method may further include:
in response to a sliding operation that is continuous with the touch operation and a sliding end point exceeds the first preset range, cancelling the visual identification of the target virtual object identification;
in response to a sliding operation that is continuous with the touch operation and the sliding end point exceeds the second preset range, hiding the virtual object identification displayed in the first user interface.

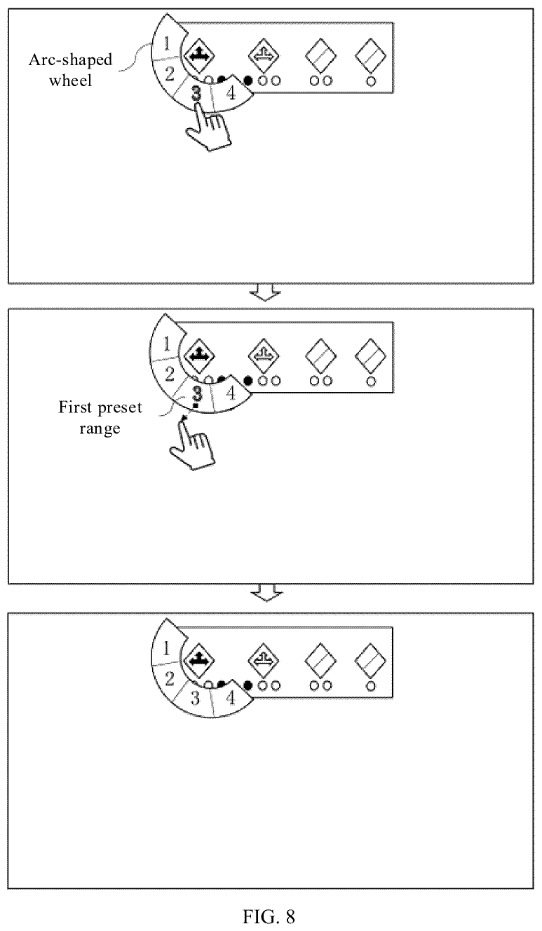

In this embodiment, if the user selects the wrong target virtual object identification, the visual identification of the target virtual object identification can be canceled by performing a sliding operation that is continuous with the touch operation and the sliding end point exceeds the first preset range, that is, the selected target virtual object identification is canceled. For example, as shown in FIG. 8, the arc-shaped wheel is the cluster layer. The first preset range can refer to the area where the target virtual object identification is located, such as the area where the virtual object identification 3 is located in FIG. 8. If the touch point moves from the area where the virtual object identification 3 is located to outside the area where the virtual object identification 3 is located and then disappears, then the virtual object identification 3 returns to normal display to prompt the user that the target virtual object identification is not currently selected.

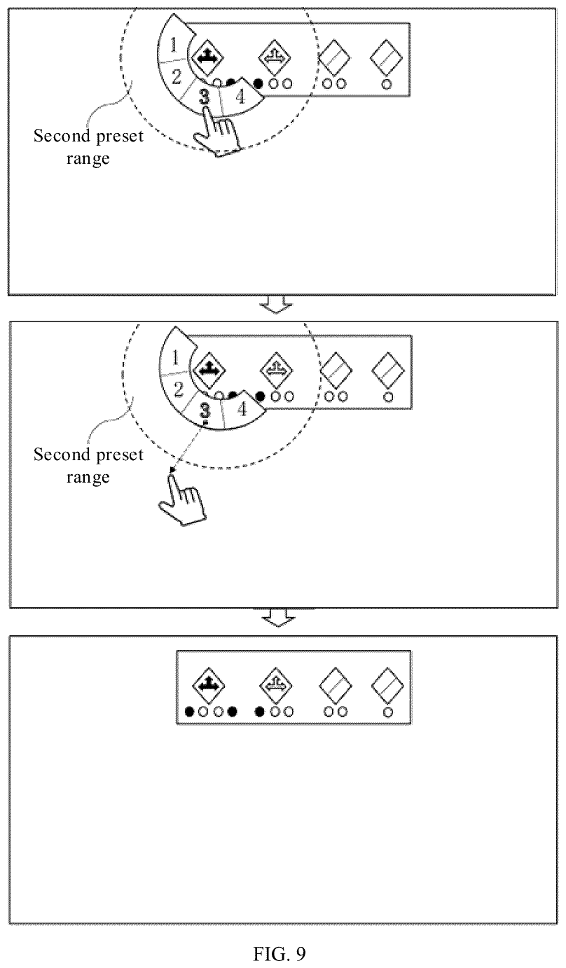

When it is detected that the user performs a sliding operation that is continuous with the touch operation and the sliding end point exceeds the second preset range, the virtual object identification displayed in the first user interface in response to the second trigger operation for the first target task icon is hidden. When a virtual object identification is displayed through a cluster layer, the cluster layer is hidden. The second preset range is greater than or equal to the first preset range. That is, when a sliding operation that is continuous with the touch operation and the sliding end point exceeds the second preset range is detected, the visual identification of the target virtual object identification is cancelled, and the cluster layer is hidden at the same time. For example, as shown in FIG. 9, the second preset range is an area surrounded by an arc-shaped dotted line outside the arc-shaped wheel. If the touch point moves from the area where the virtual object identification 3 is located to outside the area surrounded by the arc-shaped dotted line and then disappears, the cluster layer, that is, the virtual object identification displayed in the cluster layer disappears in the first user interface.

It should be noted that in some embodiments, there may be only the second preset range and no first preset range. When the user selects the wrong target virtual object identification, the wrong target virtual object identification can only be canceled by canceling the display of all virtual object identifications to avoid sending wrong information.

In an example, the virtual object identification(s) of part of the second virtual objects are displayed in the first user interface, that is, the virtual object identification(s) of part of the second virtual object are displayed in the cluster layer. In this case, when the target virtual object identification is not displayed on the first user interface, the user can control the virtual object identification displayed on the cluster layer to slide in the sliding direction corresponding to the second sliding operation by performing the second sliding operation on the cluster layer, to update the virtual object identification displayed by the cluster layer until the target virtual object identification is displayed in the cluster layer. Alternatively, the user can expand the display area of the cluster layer through a click operation on the second expanded display control in the cluster layer, so that all the virtual object identifications of the second virtual object are displayed in the cluster layer. Then, a third trigger operation acting on the area where the target virtual object identification is located is performed, so that the information bar displays the first interaction information.

When the cluster layer is an arc-shaped wheel around the second target task icon, the second sliding operation can be considered as a rotation operation for the arc-shaped wheel. For example, the sliding trajectory corresponding to the second sliding operation is an arc shape with the center of the circle coinciding with the center of the arc-shaped wheel. In response to a rotation operation for the arc-shaped wheel, the virtual object identification displayed in the arc-shaped wheel is updated.

Optionally, the target virtual object is one or more of the second virtual objects that are currently executing the task different from the second target task. In order to facilitate the user to select the target virtual object identification, in some optional embodiments of the present disclosure, displaying the virtual object identification(s) of at least part of the second virtual objects in the cluster layer may include:
determining a third virtual object currently executing the second target task from the second virtual objects;
graying out the virtual object identification of the third virtual object displayed in the cluster layer.

When the virtual object identification is grayed out, the virtual object identification is in an unusable state, that is, the grayed out virtual object identification cannot be used as the target virtual object identification. In this embodiment, the third virtual object is already executing the second target task. Therefore, the user does not need to suggest the third virtual object to execute the second target task any more. In this embodiment, by graying out the virtual object identification of the third virtual object currently executing the second target task, the user can be prevented from mistakenly determining the virtual object identification corresponding to the third virtual object as the target virtual object identification, thereby avoiding generation of invalid communication information.

Optionally, only valid virtual object identification(s) may be displayed in the cluster layer, where the valid virtual object identification is a virtual object identification of the second virtual object whose currently executed task is different from the second target task. That is, the virtual object identification of the third virtual object whose currently executed task is the same as the second target task is not displayed in the cluster layer.

The above-mentioned first interaction information is information proposed by the user using the first terminal and suggesting the target second virtual object to execute the second target task. This embodiment sends the first interaction information to the target second terminal, so that the first pop-up window is simultaneously displayed in the target second user interface of the target second terminal, and the first pop-up window is used to receive a response operation of whether to accept the first interaction information. In this way, it can not only prompt the user of the target second terminal, but also facilitates the user of the target second terminal to give feedback on the suggestion provided by the first terminal user, thereby achieving the effectiveness of communication.

It should be noted that while the first interaction information is displayed in the information bar, the first pop-up window is displayed in the target second user interface. The process after the target second terminal receives the first interaction information is similar to the process after the first terminal receives the second interaction information described later, which may refer to the following description.

Further, in some optional embodiments of the present disclosure, the above method may further include:
in response to second interaction information sent by the second terminal, displaying a second pop-up window on the first user interface; where the second interaction information is used to indicate the first virtual object to execute a third target task, and the second pop-up window is used to receive a response operation of whether to accept the second interaction information.

The first terminal may also receive the second interaction information sent by the second terminal. The second interaction information is used to indicate the first virtual object to execute a third target task. The third target task may be any unlocked and uncompleted virtual object that is different from the task currently executed by the first virtual object. The process of the second terminal sending the second interaction information is similar to the above-mentioned process of the first terminal sending the first interaction information to the target second terminal, which will not be elaborated here.

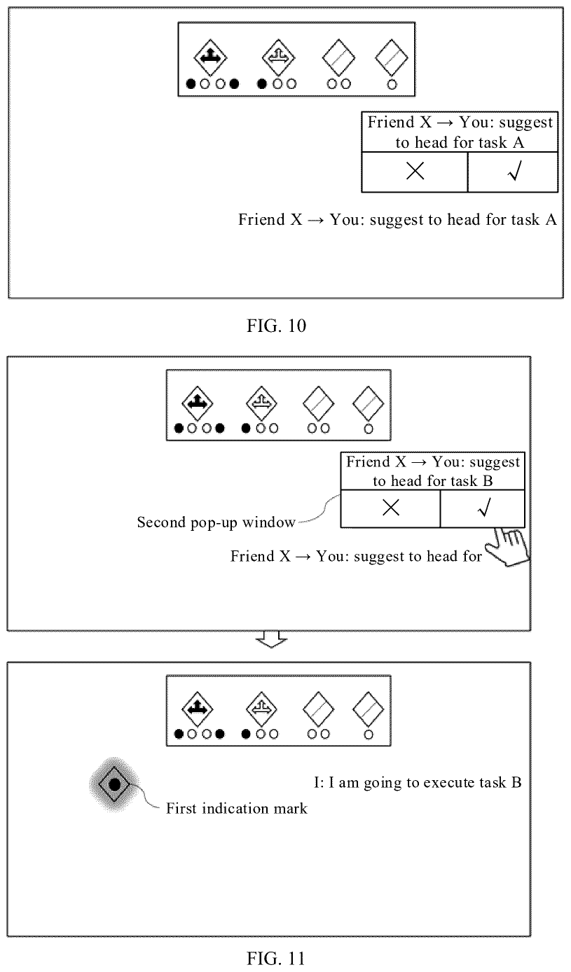

When the first terminal receives the second interaction information, a second pop-up window is displayed on the first user interface. The second pop-up window is used to receive a response operation of whether to accept the second interaction information. The first terminal user needs to respond to the second interaction information sent by the second terminal, and the second pop-up window can facilitate the first terminal user to feed back the response information to the second terminal user. As shown in FIG. 10, the second pop-up window may include the content of the first interaction information and two controls, one of the controls is an accept control and the other is a reject control. The content of the second interaction information in FIG. 10 is: “Friend X→You: suggest to head for task B.” “Friend X” in the second interactive information in FIG. 10 may be a game name of the second virtual object that sent the first interaction information, and “You” is used to represent the first virtual object.

Optionally, the above method may further include:
in response to the response operation for the second pop-up window, displaying response information corresponding to the response operation in the information bar; the response operation including an acceptance operation and a rejection operation.

Information sharing can improve communication efficiency between teammates. Therefore, in this embodiment, when a response operation for the second pop-up window is detected, the response information corresponding to the response operation is displayed in the information bar so that the second terminal user can learn the first terminal user's response to the second interaction information at the same time.

For example, the second pop-up window may include an accept control and a reject control. The operation of clicking the accept control is an acceptance operation, which indicates the consent of the first virtual object to execute the third target task. The response information of “First virtual object name: I am going to execute task B” may be displayed in the information bar, in which the “First virtual object name” may also be represented by “I”; in the second user interface of the second terminal, the corresponding display content is “First virtual object name: I am going to execute task B”, which is the response information of the first virtual object going to execute the third target task. The operation of clicking the reject control is a rejection operation, indicating that the first virtual object is not agreed to go to execute the third target task, and the response information of “First virtual object name: refuse to execute task B” may be displayed in the information bar.

Optionally, the second pop-up window is hidden in response to the acceptance operation or rejection operation acting on the second pop-up window. When the first terminal detects an acceptance operation or a rejection operation on the second pop-up window, the second pop-up window is hidden, that is, the second pop-up window disappears in the first user interface to prevent the second pop-up window from blocking the virtual environment screen.

Optionally, if no trigger operation for the second pop-up window is received within a preset display duration, it is determined that the response operation for the second pop-up window is a rejection operation.

In this embodiment, in order to prevent the second pop-up window from blocking the virtual environment screen for a long time, the second pop-up window has a preset display duration. If the first terminal user does not respond to the second pop-up window within the preset display duration of the second pop-up window, then by default the first terminal user rejects the first virtual object to execute the second target task, that is, the response operation is determined to be a rejection operation. At the same time, the corresponding response information may be displayed in the information bar.

Further, the above method may further include:
in response to the acceptance operation for the second pop-up window, displaying a second indication mark for guiding the first virtual object to go to the location corresponding to the third target task in the first user interface.

Different tasks correspond to different virtual areas in the virtual environment. When the first terminal user accepts the second interaction information, a second indication mark for guiding the first virtual object from the current task location to the location corresponding to the third target task may be displayed in the first user interface, to facilitate the user to control the first virtual object to execute the third target task.

As shown in FIG. 11, when the first terminal user accepts the second interaction information, a second indication mark may be displayed in the first user interface. The second indication mark may also be added with special effects such as flashing to serve as a conspicuous reminder. The flashing effect can last for a specified duration, such as 5 seconds. The user can control the first virtual object to move in the direction of the second indication mark, and reach the location of the third target task to execute the third target task.

When the third target task includes a plurality of subtasks, in an optional embodiment of the present disclosure, the method may further include:
in response to the acceptance operation for the second pop-up window, according to the positional relationship between the current position of the first virtual object and the task location of each subtask of the third target task, determining the second target subtask executed by the first virtual object, and displaying the second target subtask and a second indication mark in the first user interface, where the second indication mark is used to guide the first virtual object to go to the task location corresponding to the second target subtask.

This embodiment can determine the second target subtask executed by the first virtual object according to the positional relationship between the current position of the first virtual object and the task location of each subtask of the third target task, and display the second target subtask and the second indication mark on the first user interface. Optionally, the second target subtask may be the subtask that has the smallest distance or the shortest path from the current position of the first virtual object among the unlocked and uncompleted subtasks of the third target task. The second indication mark has a similar function to the previous first indication mark and is used to guide the first virtual object to go to the task location corresponding to the second target subtask. The similarity can be found in the previous description of the first indication mark and will not be elaborated here.

An optional embodiment of the present disclosure displays the virtual object identification of the second virtual object in response to the second trigger operation for the second target task icon in the task icon(s); and in response to the third trigger operation for the target virtual object identification in the virtual object identification(s), displays the first interaction information in the information bar, and sends the first interaction information to the target second virtual object corresponding to the target virtual object identification, so that the target second terminal corresponding to the target second virtual object displays the first pop-up window. The player who controls the first virtual object through the first terminal can display the first interaction information suggesting the target second virtual object to execute the second target task in the information bar through two simple trigger operations, thereby realizing information sharing, and improving communication efficiency. Meanwhile, the first interaction information suggesting the target second virtual object to execute the second target task is sent to the target second terminal corresponding to the target second virtual object, so that the target second terminal displays the first pop-up window related to the first interaction information. On the basis of information sharing, it can also make communication more targeted, thereby improving communication efficiency and reducing communication costs.

It should be noted that for the sake of simple description, for the method embodiments, they are expressed as a series of action combinations. However, those skilled in the art should know that the embodiments of the present disclosure are not limited by the described action sequence because certain steps may be performed in other orders or simultaneously according to the embodiments of the present disclosure. Secondly, those skilled in the art should also know that the embodiments described in the specification are preferred embodiments, and the actions involved are not necessarily necessary for the embodiments of the present disclosure.

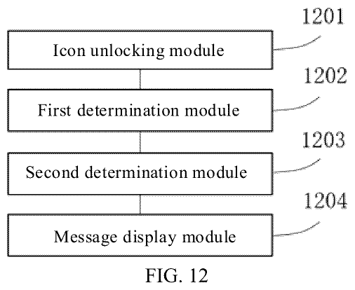

Referring to FIG. 12, FIG. 12 shows a structural block diagram of an embodiment of an information interaction apparatus of the present disclosure. Corresponding to the above-mentioned embodiments of the information interaction method, the information interaction apparatus controls the first virtual object in the game through the first terminal. In the same game, a second virtual object controlled by the second terminal is also included. It can be understood that the user can control the first virtual object through interaction operations with the first terminal, and can control the second virtual object through interaction operations with the second terminal. The first terminal provides a first user interface. The first user interface includes an icon display area and an information bar. The icon display area is used to display task icon(s) related to the current game stage and the team. The information bar is used to display chat information between the first virtual object and the second virtual object, i.e., the information bar is used to display the chat information between the virtual objects of the team to which the first virtual object belongs. That is, the information displayed in the information bar of the first user interface can be displayed synchronously to the second user interface of the second terminal. The information interaction apparatus may include the following modules:
an icon unlocking module 1201, configured to, in response to any virtual object of the team to which the first virtual object belongs completing an unlocking task, display an unlocked task icon corresponding to the unlocking task in the icon display area;
a first determination module 1202, configured to, in response to a first trigger operation for a first target task icon in the unlocked task icon(s), determine that the first virtual object executes a first target task corresponding to the first target task icon;
a second determination module 1203, configured to, according to a positional relationship between a current position of the first virtual object and a task location of each subtask of the first target task, determine a first virtual object executed by the first virtual object, and display the first target subtask and a first indication mark on the first user interface, where the first indication mark is used to guide the first virtual object to go to a task location corresponding to the first target subtask;
a message display module 1204, configured to display notification information that the first virtual object executes the first target task in the information bar of the first user interface, where the information bar is used to display the chat information between the virtual objects of the team to which the first virtual object belongs.

Optionally, the apparatus may further include:
a first display module, configured to, in response to a second trigger operation for a second target task icon in the unlocked task icon(s), display a virtual object identification of the second virtual object;
a second display module, configured to, in response to a third trigger operation for the target virtual object identification in the virtual object identification(s), display first interaction information in the information bar, where the first interaction information is used to indicate that a target second virtual object corresponding to the target virtual object identification executes the second target task corresponding to the second target task icon; and
an information sending module, configured to send the first interaction information to a target second terminal corresponding to the target second virtual object in the second terminal, so that a first pop-up window is simultaneously displayed in the target second user interface of the target second terminal A; where the first pop-up window is used to receive a response operation of whether to accept the first interaction information.

Optionally, the apparatus may further include:
a third display module, configured to, in response to second interaction information sent by the second terminal, display a second pop-up window on the first user interface; where the second interaction information is used to indicate the first virtual object to execute a third target task, and the second pop-up window is used to receive a response operation of whether to accept the second interaction information.

Optionally, the apparatus may further include:
a fourth display module, configured to, in response to the response operation for the second pop-up window, display response information corresponding to the response operation in the information bar; where the response operation includes an acceptance operation and a rejection operation.

Optionally, the apparatus may further include:
an indication mark display module, configured to, in response to the acceptance operation for the second pop-up window, according to the positional relationship between the current position of the first virtual object and the task location of each subtask of the third target task, determine a second target subtask executed by the first virtual object, and display the second target subtask and a second indication mark in the first user interface, where the second indication mark is used to guide the first virtual object to go to the task location corresponding to the second target subtask.

Optionally, the indication mark display module may include:
a rejection operation determination submodule, configured to, if no trigger operation for the second pop-up window is received within a preset display duration, determine that the response operation for the second pop-up window is the rejection operation.

Optionally, the first display module may include:
a cluster layer display submodule, configured to, in response to the second trigger operation acting on the second target task icon, generate a cluster layer, and display the cluster layer on the first user interface; and
a virtual object identification display submodule, configured to display the virtual object identification of at least part of the second virtual object in the cluster layer.

Optionally, the second display module may include:
a target virtual object identification determination submodule, configured to, in response to a touch operation acting on an area where any virtual object identification is located, add a visual identification to a virtual object identification in an area where a touch point is located, and determine the virtual object identification with the added visual identification as the target virtual object identification; and
a first interaction information display submodule, configured to, in response to the touch operation disappearing, display the first interaction information in the information bar.

Optionally, the apparatus may further include:
a visual identification cancellation module, configured to, in response to a sliding operation that is continuous with the touch operation and a sliding end point exceeds a first preset range, cancel the visual identification of the target virtual object identification;
a cluster layer hiding module, configured to, in response to a sliding operation that is continuous with the touch operation and the sliding end point exceeds a second preset range, hide the cluster layer.

Optionally, the virtual object identification display submodule may include:
a third virtual object determination unit, configured to determine a third virtual object currently executing the second target task from the second virtual object; and
a virtual object identification graying unit, configured to gray out the virtual object identification of the third virtual object displayed in the cluster layer.

Optionally, the cluster layer is in a shape of an arc-shaped wheel, and the cluster layer display submodule can be configured to display the arc-shaped wheel around the second target task icon in the first user interface.

Optionally, when the arc-shaped wheel displays an object identification(s) of part of the second virtual objects, the apparatus may further include:
a virtual object identification updating module, configured to, in response to a rotation operation for the arc-shaped wheel, update the virtual object identification displayed in the arc-shaped wheel.

Optionally, the task icon displays unlock information of a corresponding task, and/or task completion progress information, and/or the number of virtual objects currently executing the corresponding task, and/or, a maximum number of virtual objects allowed to execute the corresponding task simultaneously.

Optionally, the icon display area is used to display a task icon with the unlock information as unlocked.

Optionally, the second determination module may be further configured to display progress information of the first target subtask on the first user interface.

Optionally, the apparatus may further include:
an icon display area update module, configured to, in response to task completion progress information of the task icons in the current game stage being completed, control the first virtual object to enter a next game stage, and update the task icon displayed the icon display area.

As for the apparatus embodiments, since they are basically similar to the method embodiment, the description is relatively simple. For relevant details, the partial description of the method embodiments may be referred to.

Embodiments of the present disclosure further disclose an electronic device, including a processor, a memory, and a computer program stored on the memory and capable of running on the processor. When the computer program is executed by the processor, the following method steps are implemented:
an information interaction method, a first virtual object in a game is controlled through a first terminal, the first terminal provides a first user interface, the first user interface includes an icon display area, and the icon display area is used to display a current game stage, and a team-related task icon, the method including:
in response to any virtual object of a team to which the first virtual object belongs completing an unlocking task, displaying an unlocked task icon corresponding to the unlocking task in the icon display area;
in response to a first trigger operation for a first target task icon in the unlocked task icon(s), determining that the first virtual object executes a first target task corresponding to the first target task icon;
according to a positional relationship between a current position of the first virtual object and a task location of each subtask of the first target task, determining a first target subtask executed by the first virtual object, and displaying the first target subtask and a first indication mark on the first user interface, where the first indication mark is used to guide the first virtual object to go to a task location corresponding to the first target subtask; and
displaying notification information that the first virtual object executes the first target task in an information bar of the first user interface, where the information bar is used to display chat information between virtual objects of the team to which the first virtual object belongs.

Optionally, the game further includes a second virtual object controlled by a second terminal and in a same team as the first virtual object; the method further includes:
in response to a second trigger operation for a second target task icon in the unlocked task icon(s), displaying a virtual object identification of the second virtual object;
in response to a third trigger operation for the target virtual object identification in the virtual object identification, displaying first interaction information in the information bar, where the first interaction information is used to indicate a target second virtual object corresponding to the target virtual object identification to execute the second target task corresponding to the second target task icon; and
sending the first interaction communication to a target second terminal corresponding to the target second virtual object in the second terminal, so that a first pop-up window is simultaneously displayed in the target second user interface of the target second terminal; where the first pop-up window is used to receive a response operation of whether to accept the first interaction information.

Optionally, the method further includes:
in response to second interaction information sent by the second terminal, displaying a second pop-up window on the first user interface; where the second interaction information is used to indicate the first virtual object to execute a third target task, where the second pop-up window is used to receive a response operation of whether to accept the second interaction information.

Optionally, the method further includes:
in response to the response operation for the second pop-up window, displaying response information corresponding to the response operation in the information bar; where the response operation includes an acceptance operation and a rejection operation.

Optionally, the method further includes:
in response to the acceptance operation for the second pop-up window, according to the positional relationship between the current position of the first virtual object and the task location of each subtask of the third target task, determining a second target subtask executed by the first virtual object, and displaying the second target subtask and a second indication mark in the first user interface, where the second indication mark is used to guide the first virtual object to go to the task location corresponding to the second target subtask.

Optionally, in response to the response operation for the second pop-up window further includes:
if no trigger operation for the second pop-up window is received within a preset display duration, determining that the response operation for the second pop-up window is the rejection operation.

Optionally, displaying the virtual object identification of the second virtual object in response to the second trigger operation for the second target task icon in the unlocked task icon(s), includes:
in response to the second trigger operation acting on the second target task icon, generating a cluster layer and displaying the cluster layer on the first user interface; and
displaying the virtual object identification(s) of at least part of the second virtual objects in the cluster layer.

Optionally, in response to the third trigger operation for the target virtual object identification in the virtual object identification(s), displaying the first interaction information in the information bar includes:
in response to a touch operation acting on an area where any virtual object identification is located, adding a visual identification to a virtual object identification in an area where a touch point is located, and determining the virtual object identification with the added visual identification as the target virtual object identification; and
in response to the touch operation disappearing, displaying first interaction information in the information bar.

Optionally, after determining the virtual object identification with the added visual identification as the target virtual object identification, the method further includes:
in response to a sliding operation that is continuous with the touch operation and a sliding end point exceeds a first preset range, cancelling the visual identification of the target virtual object identification; and
in response to a sliding operation that is continuous with the touch operation and the sliding end point exceeds a second preset range, hiding the cluster layer.

Optionally, displaying the virtual object identification(s) of at least part of the second virtual objects in the cluster layer further includes:
determining a third virtual object currently executing the second target task from the second virtual object; and
graying out the virtual object identification of the third virtual object displayed in the cluster layer.

Optionally, the cluster layer is in a shape of an arc-shaped wheel, and displaying the cluster layer on the first user interface includes:
displaying the arc-shaped wheel around the second target task icon in the first user interface.

Optionally, when the arc-shaped wheel displays an object identification of a part of the second virtual objects, before responding to the second trigger operation for the target virtual object identification in the virtual object identification, the method further includes:
in response to a rotation operation for the arc-shaped wheel, updating the virtual object identification displayed in the arc-shaped wheel.

Optionally, the task icon displays unlock information of a corresponding task, and/or task completion progress information, and/or the number of virtual objects currently executing the corresponding task, and/or a maximum number of virtual objects allowed to execute the corresponding task simultaneously.

Optionally, the icon display area is used to display a task icon with the unlock information as unlocked.

Optionally, determining the first target subtask executed by the first virtual object according to the positional relationship between the current position of the first virtual object and the task location of each subtask of the first target task, further includes:
displaying progress information of the first target subtask on the first user interface.

Optionally, the method further includes:
in response to task completion progress information of the task icon in the current game stage being completed, controlling the first virtual object to enter a next game stage, and updating the task icon displayed in the icon display area.

The specific embodiment content of the information interaction method run in this embodiment is also applicable to the aforementioned embodiment content of the information interaction method, and therefore will not be elaborated here.

In the embodiments of the present disclosure, in response to any virtual object of the team to which the first virtual object belongs completing the unlocking task, the unlocked icon corresponding to the unlocking task is displayed in the icon display area; in response to the first trigger operation for the first target task icon in the unlocked task icon, it is determined that the first virtual object executes the first target task corresponding to the first target task icon; according to the positional relationship between the current position of the first virtual object and the task location of each subtask of the first target task, the first target subtask executed by the first virtual object is determined, and the first target subtask and the first indication mark are displayed on the first user interface, where the first indication mark is used to guide the first virtual object to go to the task location corresponding to the first target subtask; and notification information of the first virtual object executing the first target task is displayed in the information bar of the first user interface, where the information bar is used to display chat information between virtual objects of the team to which the first virtual object belongs. In this way, the present disclosure not only can provide a prompt for the task that the user wants to execute, but also can share information, synchronize the current task status with teammates in a targeted manner, and improve the efficiency of communication with teammates.

Embodiments of the present disclosure further disclose a computer-readable storage medium.

A computer program is stored on the computer-readable storage medium. When the computer program is performed by a processor, the following method steps are implemented:
an information interaction method, a first virtual object in a game is controlled through a first terminal, the first terminal provides a first user interface, the first user interface includes an icon display area, and the icon display area is used to display a current game stage, and a team-related task icon, the method includes:
in response to any virtual object of a team to which the first virtual object belongs completing an unlocking task, displaying an unlocked task icon corresponding to the unlocking task in the icon display area;
in response to a first trigger operation for a first target task icon in the unlocked task icon, determining that the first virtual object executes a first target task corresponding to the first target task icon;
according to a positional relationship between a current position of the first virtual object and a task location of each subtask of the first target task, determining a first target subtask executed by the first virtual object, and displaying the first target subtask and a first indication mark on the first user interface, where the first indication mark is used to guide the first virtual object to go to a task location corresponding to the first target subtask; and
displaying notification information that the first virtual object executes the first target task is in an information bar of the first user interface, where the information bar is used to display chat information between virtual objects of the team to which the first virtual object belongs.

Optionally, the game further includes a second virtual object controlled by a second terminal and in a same team as the first virtual object; the method further includes:
in response to a second trigger operation for a second target task icon in the unlocked task icon(s), displaying a virtual object identification of the second virtual object;
in response to a third trigger operation for the target virtual object identification in the virtual object identification, displaying first interaction information in the information bar, where the first interaction information is used to indicate a target second virtual object corresponding to the target virtual object identification to execute the second target task corresponding to the second target task icon; and
sending the first interaction information to a target second terminal corresponding to the target second virtual object in the second terminal, so that a first pop-up window is simultaneously displayed in the target second user interface of the target second terminal; where the first pop-up window is used to receive a response operation of whether to accept the first interaction information.

Optionally, the method further includes:
in response to second interaction information sent by the second terminal, displaying a second pop-up window on the first user interface; where the second interaction information is used to indicate the first virtual object to execute a third target task, where the second pop-up window is used to receive a response operation of whether to accept the second interaction information.

Optionally, the method further includes:
in response to the response operation for the second pop-up window, displaying response information corresponding to the response operation in the information bar; where the response operation includes an acceptance operation and a rejection operation.

Optionally, the method further includes:
in response to the acceptance operation for the second pop-up window, according to the positional relationship between the current position of the first virtual object and the task location of each subtask of the third target task, determining a second target subtask executed by the first virtual object, and displaying the second target subtask and a second indication mark in the first user interface, where the second indication mark is used to guide the first virtual object to go to the task location corresponding to the second target subtask.

Optionally, in response to the response operation for the second pop-up window further includes: if no trigger operation for the second pop-up window is received within a preset display duration, determining that the response operation for the second pop-up window is the rejection operation.

Optionally, displaying the virtual object identification of the second virtual object in response to the second trigger operation for the second target task icon in the unlocked task icon, includes:
in response to the second trigger operation acting on the second target task icon, generating a cluster layer and displaying the cluster layer on the first user interface; and
displaying the virtual object identification(s) of at least part of the second virtual object(s) in the cluster layer.

Optionally, in response to the third trigger operation for the target virtual object identification in the virtual object identification(s), displaying the first interaction information in the information bar includes:
in response to a touch operation acting on an area where any virtual object identification is located, adding a visual identification to a virtual object identification in an area where a touch point is located, and determining the virtual object identification with the added visual identification as the target virtual object identification; and
in response to the touch operation disappearing, displaying first interaction information in the information bar.

Optionally, after determining the virtual object identification with the added visual identification as the target virtual object identification, the method further includes:
in response to a sliding operation that is continuous with the touch operation and a sliding end point exceeds a first preset range, cancelling the visual identification of the target virtual object identification; and
in response to a sliding operation that is continuous with the touch operation and the sliding end point exceeds a second preset range, hiding the cluster layer.

Optionally, displaying the virtual object identification(s) of at least part of the second virtual object(s) in the cluster layer further includes:
determining a third virtual object currently executing the second target task from the second virtual object; and
graying out the virtual object identification of the third virtual object displayed in the cluster layer.

Optionally, the cluster layer is in a shape of an arc-shaped wheel, and displaying the cluster layer on the first user interface includes:
displaying the arc-shaped wheel around the second target task icon in the first user interface.

Optionally, when the arc-shaped wheel displays an object identification of a part of the second virtual objects, before responding to the second trigger operation for the target virtual object identification in the virtual object identification, the method further includes:
in response to a rotation operation for the arc-shaped wheel, updating the virtual object identification displayed in the arc-shaped wheel.

Optionally, the task icon displays unlock information of a corresponding task, and/or task completion progress information, and/or the number of virtual object(s) currently executing the corresponding task, and/or, a maximum number of virtual objects allowed to execute the corresponding task simultaneously.

Optionally, the icon display area is used to display a task icon with the unlock information as unlocked.

Optionally, determining the first target subtask executed by the first virtual object according to the positional relationship between the current position of the first virtual object and the task location of each subtask of the first target task, further include:
displaying progress information of the first target subtask on the first user interface.

Optionally, the method further includes:
in response to task completion progress information of the task icon(s) in the current game stage being completed, controlling the first virtual object to enter a next game stage, and updating the task icon displayed in the icon display area.

The specific embodiment content of the information interaction method run in this embodiment is also applicable to the aforementioned embodiment content of the information interaction method, and therefore will not be elaborated here.

In the embodiments of the present disclosure, in response to any virtual object of the team to which the first virtual object belongs completing the unlocking task, the unlocked icon corresponding to the unlocking task is displayed in the icon display area; in response to the first trigger operation for first target task icon in the unlocked task icon, it is determined that the first virtual object executes the first target task corresponding to the first target task icon; according to the positional relationship between the current position of the first virtual object and the task location of each subtask of the first target task, the first target subtask executed by the first virtual object is determined, and the first target subtask and the first indication mark are displayed on the first user interface, where the first indication mark is used to guide the first virtual object to go to the task location corresponding to the first target subtask; and notification information of the first virtual object executing the first target task is displayed in the information bar of the first user interface, where the information bar is used to display chat information between virtual objects of the team to which the first virtual object belongs. In this way, the present disclosure not only can provide a prompt for the task that the user wants to execute, but also can share information, synchronize the current task status with teammates in a targeted manner, and improve the efficiency of communication with teammates.

Various embodiments in this specification are described in a progressive manner. Each embodiment focuses on its differences from other embodiments. The same and similar parts between the various embodiments can be referred to each other.

It should be understood by those skilled in the art that the embodiments of the present disclosure may be provided as methods, apparatuses, or computer program products. Accordingly, the embodiments of the present disclosure may take the form of an entirely hardware embodiment, an entirely software embodiment, or an embodiment that combines software and hardware aspects. Furthermore, the embodiments of the present disclosure may take the form of a computer program product embodied on one or more computer-usable storage media (including, but not limited to, a disk storage, a CD-ROM, an optical storage, etc.) having computer-usable program codes therein.

The embodiments of the present disclosure are described with reference to flowchart illustrations and/or block diagrams of methods, terminal devices (systems), and computer program products according to the embodiments of the present disclosure. It should be understood that each process and/or block in the flowchart illustrations and/or block diagrams, and combinations of processes and/or blocks in the flowchart illustrations and/or block diagrams, can be implemented by computer program instructions. These computer program instructions may be provided to a processor of a general-purpose computer, special-purpose computer, embedded processor, or other programmable data processing terminal device to produce a machine such that the instructions are performed by the processor of the computer or other programmable data processing terminal device to produce an apparatus for implementing the functions specified in a process or processes of the flowchart diagrams and/or a block or blocks of the block diagrams.

These computer program instructions may also be stored in a computer-readable memory that causes a computer or other programmable data processing terminal device to operate in a particular manner, such that the instructions stored in the computer-readable memory produce an article of manufacture including an instruction apparatus, the instruction apparatus implementing the functions specified in a process or processes of the flowchart diagrams and/or a block or blocks of the block diagrams.

These computer program instructions may also be loaded onto a computer or other programmable data processing terminal device, so that a series of operating steps are performed on the computer or other programmable terminal device to produce computer-implemented processing, thereby causing the instructions performed on the computer or other programmable terminal device to provide steps for implementing the functions specified in a process or processes of the flowchart diagrams and/or a block or blocks of the block diagrams.

Although preferred embodiments of the embodiments of the present disclosure have been described, those skilled in the art will be able to make additional changes and modifications to these embodiments once the basic inventive concepts are apparent. Therefore, it is intended that the appended claims be construed to include the preferred embodiments and all changes and modifications that fall within the scope of the embodiments of the present disclosure.

Finally, it should be noted that in the present disclosure, relational terms such as first and second are only used to distinguish one entity or operation from another entity or operation, and do not necessarily require or imply that there is any such actual relationship or sequence between these entities or operations. Furthermore, the terms “comprise/include”, “contain”, or any other variation thereof are intended to cover a non-exclusive inclusion such that a process, method, article, or terminal device includes not only those elements but also other elements not expressly listed or inherent in the process, method, article, or terminal device. Without further limitation, an element defined by the statement “comprises/includes a. ” does not exclude the presence of additional identical elements in a process, method, article or terminal device including the stated element.

The information interaction method and apparatus, electronic device and storage medium provided by the present disclosure have been introduced in detail above. Specific examples are used in the present disclosure to illustrate the principles and implementations of the present disclosure. The description of the above embodiments is only intended to assist in understanding the methods and core ideas of the present disclosure; at the same time, for those of ordinary skill in the art, there will be changes in the specific implementation methods and application scope based on the ideas of the present disclosure. In summary, the content of this specification should not be construed as limitations on the present disclosure.

1. An information interaction method, wherein a first virtual object in a game is controlled through a first terminal, the first terminal provides a first user interface, the first user interface comprises an icon display area, and the icon display area is used to display a current game stage, and a team-related task icon, the method comprising:
in response to any virtual object of a team to which the first virtual object belongs completing an unlocking task, displaying an unlocked task icon corresponding to the unlocking task in the icon display area;
in response to a first trigger operation for a first target task icon in the unlocked task icon, determining that the first virtual object executes a first target task corresponding to the first target task icon;
according to a positional relationship between a current position of the first virtual object and a task location of each subtask of the first target task, determining a first target subtask executed by the first virtual object, and displaying the first target subtask and a first indication mark on the first user interface, wherein the first indication mark is used to guide the first virtual object to go to a task location corresponding to the first target subtask; and
displaying notification information that the first virtual object executes the first target task in an information bar of the first user interface, wherein the information bar is used to display chat information between virtual objects of the team to which the first virtual object belongs.

2. The method according to claim 1, wherein the game further comprises a second virtual object controlled by a second terminal and in a same team as the first virtual object; the method further comprises:
in response to a second trigger operation for a second target task icon in the unlocked task icon, displaying a virtual object identification of the second virtual object;
in response to a third trigger operation for a target virtual object identification in the virtual object identification, displaying first interaction information in the information bar, wherein the first interaction information is used to indicate a target second virtual object corresponding to the target virtual object identification to execute the second target task corresponding to the second target task icon; and
sending the first interaction information to a target second terminal corresponding to the target second virtual object in the second terminal, so that a first pop-up window is simultaneously displayed in a target second user interface of the target second terminal; wherein the first pop-up window is used to receive a response operation of whether to accept the first interaction information.

3. The method according to claim 2, further comprising:
in response to second interaction information sent by the second terminal, displaying a second pop-up window on the first user interface; wherein the second interaction information is used to indicate the first virtual object to execute a third target task, wherein the second pop-up window is used to receive a response operation of whether to accept the second interaction information.

4. The method according to claim 3, further comprising:
in response to the response operation for the second pop-up window, displaying response information corresponding to the response operation in the information bar; wherein the response operation comprises an acceptance operation and a rejection operation.

5. The method according to claim 4, further comprising:
in response to the acceptance operation for the second pop-up window, according to a positional relationship between the current position of the first virtual object and a task location of each subtask of the third target task, determining a second target subtask executed by the first virtual object, and displaying the second target subtask and a second indication mark in the first user interface, wherein the second indication mark is used to guide the first virtual object to go to a task location corresponding to the second target subtask.

6. The method according to claim 4, wherein in response to the response operation for the second pop-up window further comprises:
in a case that no trigger operation for the second pop-up window is received within a preset display duration, determining that the response operation for the second pop-up window is the rejection operation.

7. The method according to claim 2, wherein displaying the virtual object identification of the second virtual object in response to the second trigger operation for the second target task icon in the unlocked task icon, comprises:
in response to the second trigger operation acting on the second target task icon, generating a cluster layer and displaying the cluster layer on the first user interface; and
displaying the virtual object identification of at least part of the second virtual objects in the cluster layer.

8. The method according to claim 7, wherein in response to the third trigger operation for the target virtual object identification in the virtual object identification, displaying the first interaction information in the information bar comprises:
in response to a touch operation acting on an area where any virtual object identification is located, adding a visual identification to a virtual object identification in an area where a touch point is located, and determining the virtual object identification with the added visual identification as the target virtual object identification; and
in response to the touch operation disappearing, displaying the first interaction information in the information bar.

9. The method according to claim 8, wherein after determining the virtual object identification with the added visual identification as the target virtual object identification, the method further comprises:
in response to a sliding operation that is continuous with the touch operation and a sliding end point exceeds a first preset range, cancelling the visual identification of the target virtual object identification; and
in response to a sliding operation that is continuous with the touch operation and a sliding end point exceeds a second preset range, hiding the cluster layer.

10. The method according to claim 9, wherein displaying the virtual object identification of at least part of the second virtual objects in the cluster layer further comprises:
determining a third virtual object currently executing the second target task from the second virtual objects; and
graying out a virtual object identification of the third virtual object displayed in the cluster layer.

11. The method according to claim 10, wherein the cluster layer is in a shape of an arc-shaped wheel, and displaying the cluster layer on the first user interface comprises:
displaying the arc-shaped wheel around the second target task icon in the first user interface.

12. The method according to claim 11, wherein in response to that the arc-shaped wheel displays the virtual object identification of part of the second virtual objects, before responding to the second trigger operation for the target virtual object identification in the virtual object identification, the method further comprises:
in response to a rotation operation for the arc-shaped wheel, updating the virtual object identification displayed in the arc-shaped wheel.

13. The method according to claim 1, wherein the task icon displays at least one of unlock information of a corresponding task, task completion progress information, a number of virtual object currently executing the corresponding task or, a maximum number of virtual objects allowed to execute the corresponding task simultaneously.

14. The method according to claim 13, wherein the icon display area is used to display a task icon of which the unlock information indicates an unlocked state.

15. The method according to claim 1, wherein determining the first target subtask executed by the first virtual object according to the positional relationship between the current position of the first virtual object and the task location of each subtask of the first target task, further comprises:
displaying progress information of the first target subtask on the first user interface.

16. The method according to claim 1, further comprising:
in response to task completion progress information of the task icon in the current game stage being completed, controlling the first virtual object to enter a next game stage, and updating the task icon displayed in the icon display area.

17. (canceled)

18. An electronic device, comprising a processor, a memory, and a computer program stored on the memory and capable of running on the processor, wherein a first virtual object in a game is controlled through the electronic device, the electronic device provides a first user interface, the first user interface comprises an icon display area, and the icon display area is used to display a current game stage, and a team-related task icon, and wherein when the computer program is performed by the processor, the processor is configured to:
in response to any virtual object of a team to which the first virtual object belongs completing an unlocking task, display an unlocked task icon corresponding to the unlocking task in the icon display area;
in response to a first trigger operation for a first target task icon in the unlocked task icon, determine that the first virtual object executes a first target task corresponding to the first target task icon;
according to a positional relationship between a current position of the first virtual object and a task location of each subtask of the first target task, determine a first target subtask executed by the first virtual object, and display the first target subtask and a first indication mark on the first user interface, wherein the first indication mark is used to guide the first virtual object to go to a task location corresponding to the first target subtask; and
display notification information that the first virtual object executes the first target task in an information bar of the first user interface, wherein the information bar is used to display chat information between virtual objects of the team to which the first virtual object belongs.

19. A non-transitory computer-readable storage medium, wherein a first virtual object in a game is controlled through a first terminal, the first terminal provides a first user interface, the first user interface comprises an icon display area, and the icon display area is used to display a current game stage, and a team-related task icon, wherein a computer program is stored on the computer-readable storage medium, and when the computer program is executed by a processor, and the processor is configured to:
in response to any virtual object of a team to which the first virtual object belongs completing an unlocking task, display an unlocked task icon corresponding to the unlocking task in the icon display area;
in response to a first trigger operation for a first target task icon in the unlocked task icon, determine that the first virtual object executes a first target task corresponding to the first target task icon;
according to a positional relationship between a current position of the first virtual object and a task location of each subtask of the first target task, determine a first target subtask executed by the first virtual object, and display the first target subtask and a first indication mark on the first user interface, wherein the first indication mark is used to guide the first virtual object to go to a task location corresponding to the first target subtask; and
display notification information that the first virtual object executes the first target task in an information bar of the first user interface, wherein the information bar is used to display chat information between virtual objects of the team to which the first virtual object belongs.

20. The electronic device according to claim 18, wherein the game further comprises a second virtual object controlled by a second terminal and in a same team as the first virtual object; and the processor is further configured to:
in response to a second trigger operation for a second target task icon in the unlocked task icon, display a virtual object identification of the second virtual object;
in response to a third trigger operation for a target virtual object identification in the virtual object identification, display first interaction information in the information bar, wherein the first interaction information is used to indicate a target second virtual object corresponding to the target virtual object identification to execute the second target task corresponding to the second target task icon; and
send the first interaction information to a target second terminal corresponding to the target second virtual object in the second terminal, so that a first pop-up window is simultaneously displayed in a target second user interface of the target second terminal;
wherein the first pop-up window is used to receive a response operation of whether to accept the first interaction information.

21. The electronic device according to claim 20, wherein the processor is further configured to:
in response to second interaction information sent by the second terminal, display a second pop-up window on the first user interface; wherein the second interaction information is used to indicate the first virtual object to execute a third target task, wherein the second pop-up window is used to receive a response operation of whether to accept the second interaction information.
